(19) United States
(12) Patent Application Publication
(10) Pub. No.: US 2011/0208665 A1
(43) Pub. Date: Aug. 25, 2011

(54) METHODS AND APPARATUS FOR EMPLOYMENT QUALIFICATION ASSESSMENT

(76) Inventors: Guy Pinchas Hirsch, San Francisco, CA (US); Mariya Genzel, Mountain View, CA (US)

(21) Appl. No.: 13/034,528

(22) Filed: Feb. 24, 2011

Related U.S. Application Data
(60) Provisional application No. 61/307,784, filed on Feb. 24, 2010.

(51) Int. Cl. G06Q 10/00; G06F 15/16

(52) U.S. Cl. 705/321; 709/203

(57) ABSTRACT

A qualification processing system configured to dynamically collect and/or analyze information associated with a client and/or a candidate via an automated system and method.

### CROSS-REFERENCE TO RELATED APPLICATIONS

This application claims priority to, and the benefit of, U.S. Application Ser. No. 61/307,784, filed on Feb. 24, 2010, titled “Methods And Apparatus For Employment Qualification Assessment,” the entire contents of which is incorporated herein by reference.

### FIELD

Embodiments generally relate to apparatuses, methods, devices, and systems to evaluate a candidate or candidate response (e.g., voice response), and more particularly, to apparatuses, methods, devices, and systems that autonomically evaluate one or more candidates or candidate responses for a market research, customer surveys, sales calls, scheduling calls, replenish calls, and/or occupational activities.

### BACKGROUND

The traditional process of calling and interviewing people in large volume or recruiting candidates can be time-consuming and inefficient. Thus, a need exists for an apparatus and method to collect and/or analyze information about, for example, a candidate for a particular occupation, or customer satisfaction after a purchase or the customer receiving a service, or employee satisfaction on continual basis, or citizen's opinion about policies, and so forth.

### SUMMARY

A qualification processing system configured to dynamically collect and/or analyze information associated with a client and/or a candidate via an automated system and methods is presented.

A computer program product, a method, and an article of manufacture to select a candidate for an occupational activity is presented. Client information about an occupational activity is received from a client and candidate information about a career aspiration of a plurality of candidates is received from corresponding candidates. A candidate is autonomically selected for further inquiry. A set of queries for the candidate is determined based on at least the client information and the candidate information. A transmission is formed including at least one query from the set of quarries for delivery to the candidate. A response to the at least one query is received from the candidate. And determination is autonomically made whether the candidate is a potential match for the occupational activity based on the client information, the candidate information, and the response. A transmission is formed including the data about the potential match for delivery to at least one of the client and the candidate.

In another embodiment, client information about an activity of a client is received. The activity may be evaluation of one or more candidates or candidate responses for a market research, customer surveys, political surveys, sales calls, scheduling calls, replenish calls, and/or occupational activities, for example. A set of candidates for inquiry regarding the activity is autonomically selected. A query, from a set of queries, is sent to each of the candidates in the set and corresponding responses is received. A set of tasks for evaluating the responses is autonomically determined. Tasks are sent to evaluators that are not affiliated with the client. The evaluators assess the responses based on the task, which are then used to autonomically evaluate the response of the candidate.

### BRIEF DESCRIPTION OF THE DRAWINGS

The invention will be better understood from a reading of the following detailed description taken in conjunction with the drawings in which like reference designators are used to designate like elements, and in which:

FIG. 1 illustrates Applicants' qualification processing system that includes a qualification processing module and a database, according to an embodiment;

FIG. 2 summarizes methods and/or processes related to information collection, according to an embodiment;

FIG. 3 summarizes a method for collecting information, according to an embodiment;

FIG. 4 illustrates analysis performed by Applicants' qualification processing system;

FIG. 5 illustrates client display and evaluation;

FIG. 6 summarizes Applicants' candidate-driven process;

FIG. 7 summarizes Applicants' client-driven process, according to an embodiment;

FIG. 8 illustrates at least a portion of the database shown in FIG. 1;

FIG. 9 illustrates processing of candidate information and/or client information;

FIG. 10 summarizes certain steps of Applicants' method for selecting one or more candidates for an occupational activity;

FIG. 11 summarizes certain steps of another Applicants' method for selecting one or more candidates for an occupational activity; and

FIG. 12 summarizes additional steps of Applicants' method in for selecting one or more candidates for an occupational activity.

### DETAILED DESCRIPTION

Embodiments are described in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment. It is noted that, as used in this description, the singular forms “a,” “an” and “the” include plural referents unless the context clearly dictates otherwise. Thus, for example, the term “a query” is intended to mean a single query or a combination of queries.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

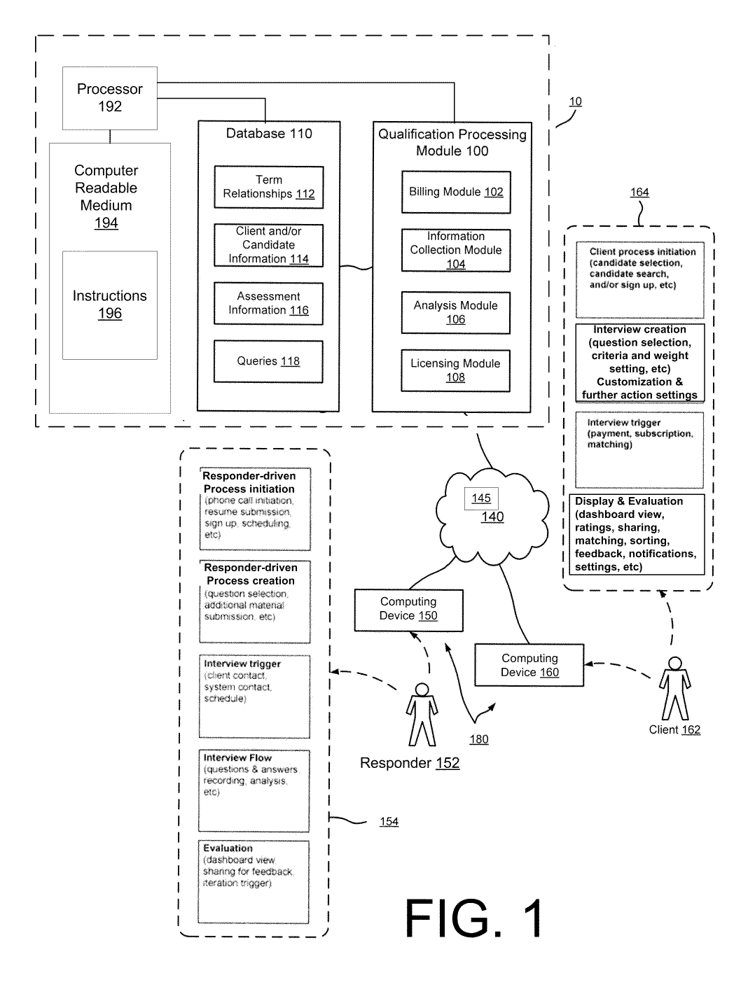

Many of the functional units described in this specification have been labeled as modules (e.g., module 100, FIG. 1) in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically collocated, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

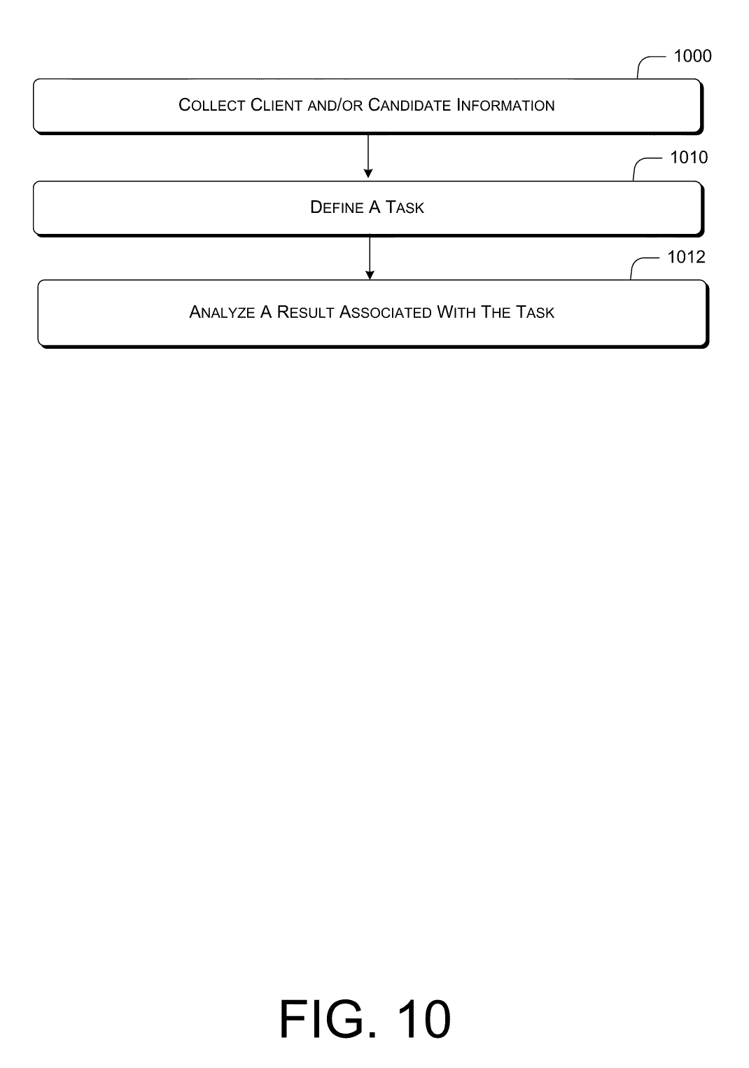

The schematic flow chart diagrams included are generally set forth as a logical flow-chart diagram (e.g., FIGS. 10-12). As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method (e.g., FIGS. 10-12). Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

A qualification processing system can be configured to automatically, autonomically, and/or dynamically facilitate processing of responder information (e.g., survey responses, or resume . . . etc.) of a responder for an activity (e.g., a market research; customer surveys; sales calls; scheduling calls; replenish calls; or an “occupational activity” such as a profession, a service, employment, a task, or a job, for example) and/or client information of a client requesting assistance with the activity.

In some embodiments, the responder information can be provided by a responder via a computing device in response to one or more queries (also can be referred to as questions in certain contexts). For example, the responder information can include a response (e.g., a textual response, a spoken and recorded response) to an interview question during one or more information collection sessions about, for example, the career aspirations of the candidate or consumer intentions toward a product or customer sentiments about a service, or a market survey analysis. The responder information can be stored in one or more databases in a variety of media formats (e.g., a textual format, a visual format, an audio format, a video format) so that the responder information can be, for example, accessed at a later time. Similarly, client information can be provided to the qualification processing system by a client via a computing device. In some embodiments, the candidate information and/or the client information can be analyzed to define, for example, rating information (of the client and/or the candidate) that can be used by a candidate and/or a client.

In some embodiments, a method is presented to enable the client to provide supporting background material and configure methods for selecting and evaluating responders. The responder is queried with an interaction that is based on at least the client's configuration and algorithmic determination of the appropriate querying given client's background material, responder's background material, and responder's previous responses. The responses to the interaction with the responder are collected, recorded, and analyzed. Based on the responses, the responder may be automatically selected for further query, automatic determination, or a set of pre-defined transactions. At least one of the client and the candidate are notified via automatic/autonomic transmission as to results of the interaction.

In some embodiments, candidate information and/or client information can be automatically and/or dynamically collected in response to one or more queries during an information collection session (e.g., an interview session). Queries for soliciting candidate information and/or client information can be defined by a candidate and/or a client (in a customized fashion) via a computing device so that the client can identify a desirable candidate for performing one or more activities and/or so that the candidate can identify an activity desirable to the candidate. In some embodiments, the queries can be defined by the responder and/or the client based on, for example, one or more parameters associated with (e.g., defining) the activity. In some embodiments, the client can be referred to as a requestor and can be, for example, a corporation, a manufacturer, an employer, a manager, an administrator, and/or so forth, and the responder can be referred to as a candidate, an applicant, a job-seeker, a customer, an employee, a professional, a resident, survey respondent, a customer, a consumer and/or so forth. Therefore, in some embodiments, responder is synonymous with candidate and responder information is synonymous with candidate information. In other embodiments, responder has a different meaning than candidate and, in turn, responder device and responder information also have a different meaning than candidate device and candidate information, respectively.

In some embodiments, the qualification processing system can be configured to process a relatively large amount of responder information and/or client information automatically and/or dynamically so that responses, skills, adaptability, fit, sentiment, interest, and/or so forth of a responder and/or a client can be assessed in an efficient manner. In sum, the qualification processing system can be an interactive system configured to dynamically collect and/or analyze information associated with a client and/or a responder via an automated system (e.g., an automated voice-based system) and methods.

FIG. 1 is a schematic diagram that illustrates a qualification processing system 10 that includes a qualification processing module 100 and a database 110, according to an embodiment. As shown in FIG. 1, the qualification processing system 10 can be accessed by a responder 152 and/or a client 162 via a communication fabric 140. Although one processing module 100, one database 110, one responder 152, and one client 162 are shown in FIG. 1, it will be apparent that any number of modules, databases, candidates and clients can be part of the system in FIG. 1, and further that, while one communication fabric 140 is shown, any number of communication fabrics 140 could also be provided in the system of FIG. 1.

Specifically, the responder 152 accesses the qualification processing system 10 via the communication fabric 140 using computing device 150. In some embodiments, the computing device 150 is referred to herein as a responder device. Similarly, the client 162 accesses the qualification processing system 10 via the communication fabric 140 using computing device 160. In some embodiments, the computing device 160 is referred to herein as a client device.

In some embodiments, the qualification processing module 100 improves efficiency (e.g., turnaround time) and/or the impartiality of evaluation of data (e.g., client information and/or responder information) related to employment qualification assessment, consumer interest in the product, or customer satisfaction. Employment qualification assessment can include, for example, matching candidates with potential employers. Consumer interest assessment can include, for example, placing a consumer into the client sales leads queue.

The communication fabric 140 comprises one or more switches 145. In certain embodiments, communication fabric 140 comprises the Internet, an intranet, an extranet, a storage area network (SAN), a wide area network (WAN), a local area network (LAN), a virtual private network, a satellite communications network implemented as a wired and/or wireless network with one or more segments in a variety of environments such as, for example, an office complex. The communication fabric 140 may contain either or both wired or wireless connections for the transmission of signals including electrical connections, magnetic connections, or a combination thereof. Examples of these types of connections are known in the art and include: radio frequency connections, optical connections, telephone links, a Digital Subscriber Line, or a cable link. Moreover, networks may utilize any of a variety of communication protocols, such as Transmission Control Protocol/Internet Protocol (TCP/IP), for example.

In some embodiments, the qualification processing system 10 can be directly accessed (not via a network) by the responder 152 and/or the client 162 via, for example, a user interface that may or may not include a visual display device. In some embodiments, the client 162 and/or the responder 152 can access the qualification processing system 10 via the same computing device.

The computing device 150 and the computing device 160 can be collectively referred to as computing devices 180. In some embodiments, the computing device(s) 180 may each be an article of manufacture such as a server, a mainframe computer, a mobile telephone, a personal digital assistant, a personal computer, a laptop, an email enabled device, a web enabled device having one or more processors (e.g., a Central Processing Unit, a Graphical Processing Unit, or a microprocessor), and/or so forth, that is configured to execute an algorithm (e.g., a computer readable program code or software) to receive data, transmit data, store data, or performing methods or other special purpose computer.

In certain embodiments, each computing device 180 comprises a non-transitory computer readable medium readable medium having a series of instructions, such as computer readable program code, encoded therein. In certain embodiments, the non-transitory computer readable medium comprises one or more data repositories. The computing device(s) 180 may include wired and wireless communication devices which can employ various communication protocols including near field (e.g., “Blue Tooth”) and far field communication capabilities (e.g., satellite communication or communication to cell sites of a cellular network) that support any number of services such as: Short Message Service (SMS) for text messaging, Multimedia Messaging Service (MMS) for transfer of photographs and videos, or electronic mail (email) access.

By way of example, the computing device(s) 180 may be as a server, including a processor, a non-transitory computer readable medium, an input/output means (e.g., a keyboard, a mouse, a stylus and touch screen, or a printer) or, and a data repository. The processor accesses executable code stored on the non-transitory computer readable medium of the computing device(s) 180, and executes one or more instructions to, for example, electronically communicate via the communication fabric 140.

In some embodiments, the database 110 can be a consolidated and/or distributed database. In some embodiments, the database 110 can be implemented as a database that is local to the qualification processing module 100 and/or can be implemented as a database that is remote to the qualification processing module 100. In some embodiments, the database 110 can be encoded in a memory included in the qualification processing module 100 and/or included in a system that includes the qualification processing module 100. The database 110 may be encoded in one or more hard disk drives, tape cartridge libraries, optical disks, or any suitable volatile or nonvolatile storage medium, storing one or more databases, or the components thereof, or as an array such as a Direct Access Storage Device (DASD), redundant array of independent disks (RAID), virtualization device, . . . etc. The database 110 may be structured by a database model, such as a relational model or a hierarchical model.

In some embodiments, one or more portions of the qualification processing system 10 can be implemented as a web-based software application. Although not shown, in some embodiments, at least one or more portions of the qualification processing system 10 can be implemented as a software and/or hardware module that can be locally executed on one or more of the computing devices 180. In such instances, other functionality of the qualification processing system 10 can be accessed via the communication fabric 140. For example, a software application locally installed at the computing device 150 can be used to access at least a portion of the qualification processing system 10.

In some embodiments, a web-based interface locally executed and/or displayed at the computing device 150 can be used to access at least a portion of the qualification processing system 10. Accordingly, the client 162 (e.g., a hiring manager, a human resource professional, a contractor, a marketing personnel) who may be interested in, for example, accessing (for evaluation purposes or statistical analysis of marketing surveys) information about one or more candidates (such as responder 152) for a particular activity (e.g., political polling analysis, a certain job opening such as an accountant position or an account manager position, or sales calls for a particular product or service, or determination of voter intent for setting policies) can access the functionality of the qualification processing system 10 via the web-based interface. In some embodiments, the qualification processing system 10 can be configured so that the client 162, for example, may be able to place a questionnaire, or job requirement, for example, and a pre-defined set of phone interview questions through a desktop or a mobile application and/or through the use of phone or website. In some embodiments, the qualification processing system 10 can be configured so that the client may be able to define a set of text and phone interview questions, and a set of criteria for flagging follow-up for customer service.

Similarly, the responder 152 who may be interested in accessing (e.g., for job search purposes) information about a particular activity can access the functionality of the qualification processing system 10. In other words, one or more portions of the qualification processing system 10 can be triggered through, for example, a dedicated website, embedded code and/or so forth. The embedded code can be configured to identify an electronic display or a resume, an electronic communication (e.g., an email, a text message, a voice message), and/or so forth.

As shown in FIG. 1, the qualification processing module 100 includes a billing module 102, an information collection module 104, an analysis module 106, and a licensing module 108. As shown in FIG. 1, the database 110 is configured to store term relationships 112, client and/or responder information 114, assessment information 116, and queries 118. The licensing module 108 manages licenses associated with, for example, software and/or communication media.

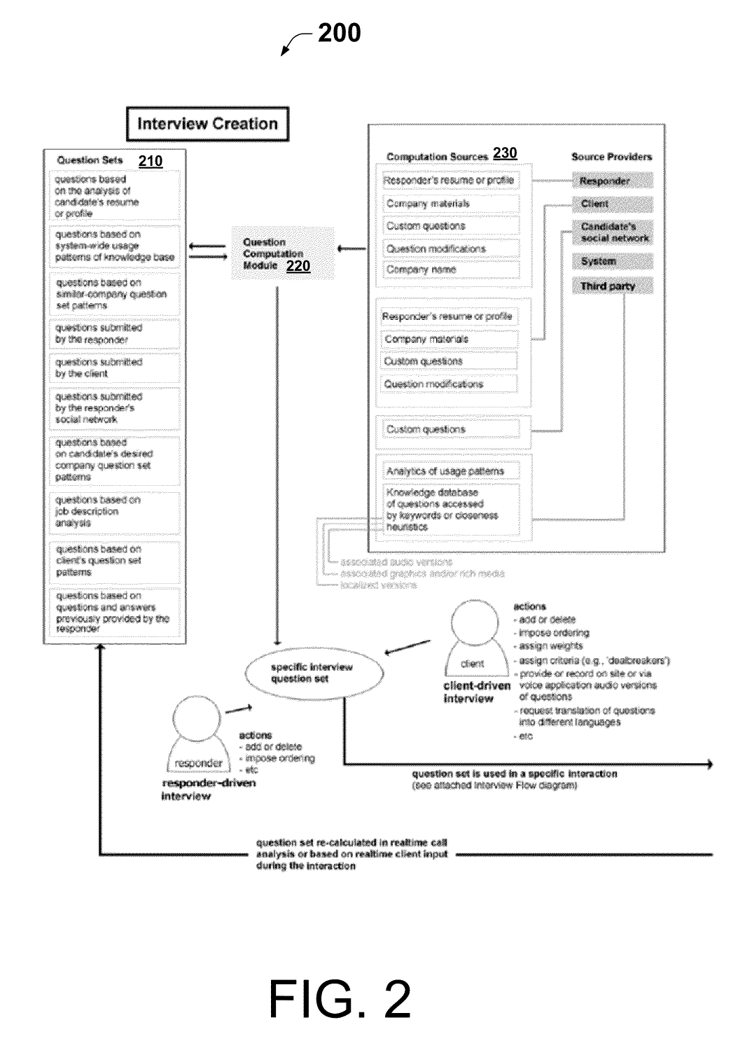

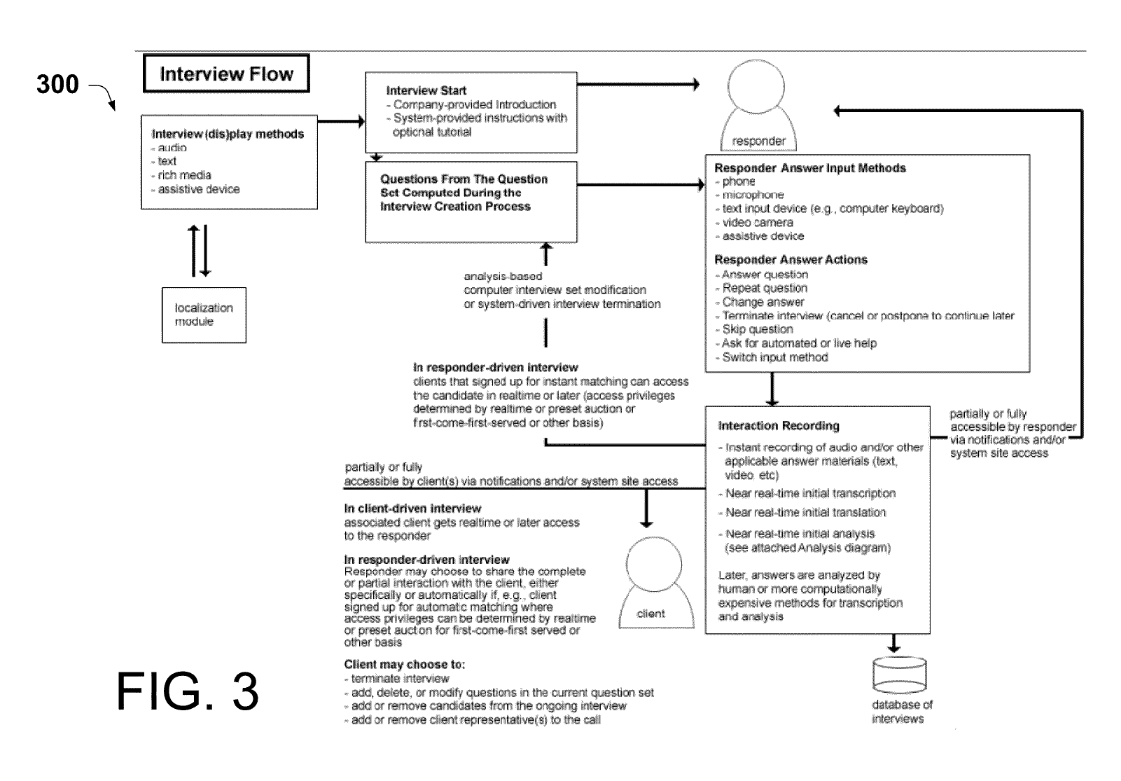

In some embodiments, the information collection module 104 communicates with the client 162 and/or the responder 152 to collect information about the client 162 and/or the responder 152 that can be used to, for example, assess the qualifications of the responder 152, the responses of the responder 152, and/or assess an aspect of the client 162. In some embodiments, for example, the responder information is collected via an interactive interview process. In some embodiments, the information collection module 104 collects information from references (via automatic reference calls). In some embodiments, the responder, the client, and/or the qualification processing system 10 can trigger an invitation for a individual identified as a reference to call in/call out and provide, for example, a written and/or audio reference for the responder 152 and/or the client 162. In some embodiments, one or more portions of the interview process can be defined by the client 162 as shown in the client-triggered functions 164. More details related to collection of information, for example, using an interview are shown in FIG. 2 and FIG. 3.

FIG. 2 Summarizes Applicant's methods and/or processes related to information collection, according to an embodiment. The information that is collected can be candidate information and/or client information. As shown in FIG. 2, question sets 210 (also can be referred to as query sets) used to solicit information can be processed by a client and/or a responder (via a computing device such as those shown in FIG. 1) using the question computation module 220 (also can be referred to as a query computation module). In some embodiments, the question computation module 220 is integral with the information collection module 104 shown in FIG. 1. The question computation module 220 can be configured to present one or more questions to a responder and/or a client (via a computing device in FIG. 1) as shown in FIG. 2. In some embodiments, the questions computation module 220 uses information from one or more computation sources 230.

In some embodiments, the question computation module 220 computes questions for one or more responders based on the analysis of one or more requirements of the activity (e.g., job requirements) and/or information about the responder such as a candidate's resume. In some embodiments, the question computation module 220 selects one or more queries (e.g., from a library of queries) based on the pattern of usage by one or more users (e.g., one or more clients, one or more responders) of the system. In some embodiments, the question computation module 220 dynamically adapts during a querying session such as an interview to responses by one or more responders.

FIG. 3 summarizes Applicant's method for collecting information, according to an embodiment. As shown in FIG. 3, the information can be collected during an interview. As shown in FIG. 3, the responder and/or the client (via computing device such as those shown in FIG. 1) is interactively involved in the information collection process. In some embodiments, the information collection can be performed via a portion of the information collection module 104 shown in FIG. 1 (e.g., the question computation module 220 shown in FIG. 2). In some embodiments, the information collected via the method disclosed in FIG. 3 is stored in an interview database. In some embodiments, the interview database is associated with the database 110 shown in FIG. 1.

In some embodiments, at least a portion of the information collection module 104 (e.g., the questions computation module 220 of the information collection module 104) autonomically revises, adds and/or subtracts any computed question/query, rank the order of the questions/queries, and/or weighs the questions/queries. These functions are performed based on one or more rules-based algorithms that can be customizable (by the client 162 and/or the responder 152). In some embodiments, at least a portion of the information collection module 104 (e.g., the questions computation module 220 of the information collection module 104) are configured so that the client 162 and/or the responder 152 may (via a computing device) revise, add and/or subtract any computed question/query, and/or rank the order of the questions/queries.

In some embodiments, the information collection module 104 (or a portion thereof) terminates an information collection session, such as for example, an interview based on real-time analysis of responses from, for example, the responder 152 and/or the client 162. In some embodiments, the information collection module 104 (or a portion thereof) modifies one or more queries (or a portion of an interview) and/or provide a different question(s) based on real-time analysis of the responses from, for example, the responder 152 and/or the client 162.

In some embodiments, the information collection module 104 (or a portion thereof) sends a notification (e.g., an indicator, a message), for example, to one or more individuals (e.g., a client) during a course of an information collection process such as an interview. For example, the information collection module 104 sends a notification that one or more persons (e.g., the client 162) should immediately intervene and/or take part in an interview with the responder 152. In some embodiments, the information collection module 104 sends a notification that one or more persons should add or subtract responders during the course of an interview with another responder, show written and/or visual questions, and/or initiate a test (e.g., a quiz) via a networked (e.g., an online) display and/or communications medium (e.g., a chat). In some embodiments, the notification can be sent via a notification module (not shown) associated with the information collection module 104. In some embodiments, the information collection module 104 communicates with the responder 152 and/or the client 162 to automatically schedule a follow-up information collection session (e.g., a follow-up interview), if necessary (as determined based on one or more rules-based algorithms). In some embodiments, the information collection module automatically makes a determination or initiates a transaction (e.g., schedules a sales visit, transfers the call to customer support, emails a coupon).

As shown in FIG. 1, the qualification processing module 100 of the qualification processing system 10 includes a billing module 102. In some embodiments, the billing module 102 processes billing and/or payments related to use of the qualification processing system 10. In some embodiments, the billing module 102 automatically processes billing and/or payments through the use of credit card, phone bill, online or offline payment systems, by linking a bank account to the system, and/or so forth. In some embodiments, the billing module 102 bills and/or collects payment from the client 162 and/or the responder 152 based on, for example, a number of interviews conducted, a number of successful interviews (as measured by a client's acceptance to trigger a follow-up action with any responder), a subscription basis, selection of the responder 152 to perform an activity, and/or so forth. The information used by the billing module 102 can be stored in the database 110.

In some embodiments, the information collection module 104 communicates with one or more responders (such as responder 152) and/or one or more clients (such as client 162). For example, the information collection module 104 automatically contacts one or more active and/or passive candidates, automatically solicits their permission to be contacted (and/or interviewed), automatically schedules an interview (and/or follow-up) with a candidate, automatically provides information (e.g., a phone number) related to an interview, automatically permits a candidate to activate an outbound call to a candidate's phone number (and/or computer), and/or allows a candidate to identify themselves by entering a dedicated personal identification number. In some embodiments, contact with a responder is automatically initiated after the responder has been automatically selected by the qualification processing system 10 (e.g., information collection module 104 of the qualification processing module 100) via a pre-screening process. The pre-screening process can be performed based on one or more rules-based algorithms including preferences defined by, for example, a client based on one or more parameters related to an activity (e.g., a job). In some embodiments, the functions described above are performed by, for example, a communication module (not shown) of the information collection module 104.

In some embodiments, an instruction module (not shown) of the qualification processing module 100) executes one or more tutorial and/or instruction sessions. The tutorial and/or instruction session can be related to any portion of the qualification processing system 10 and can be triggered to execute at a computing device of the responder 152 and/or the client 162.

In some embodiments, the qualification processing system 10 authorizes the responder 152 and/or the client 162 to control an information collection session (e.g., a question flow associated with an interview). For example, the qualification processing system 10 repeats a question, receives a response to a question, plays back a response to a question, changes a response to a question, moves on to another question, and/or asks for live help, response to an instruction from the responder 152 and/or the client 162 (via a computing device).

In some embodiments, the qualification processing system 10 records responses from the responder 152 and/or the client 162 in real-time by way of automatic application and/or through the use of human transcription service. In some embodiments, the qualification processing system 10 analyzes the response and/or computes a score (e.g., a rank) that represents, for example, the candidate's fit to a specific activity (or a general activity), and/or a general attribute.

In some embodiments, the qualification processing system 10 computes a relevancy rank based on information collected by the qualification processing system 10 such as an interview transcript, a score on a survey, a resume, a job description, demographic information, client-set criteria, any other combination of responder and/or client information. In some embodiments, the qualification processing system 10 performs a computation process enabling a relevancy rating and/or sorting of candidates (such as responder 152) for each activity before, for example, any human-to-human interaction.

In some embodiments, the qualification processing system 10 provides an assessment of a responder's and/or a client's sentiment based on computing information related to the responder and/or the client. In some embodiments, the qualification processing system 10 assesses and/or displays a responder's and/or a client's sentiment towards, for example, a question or toward the context of the question. In some embodiments, the sentiment can be a positive sentiment, a negative sentiment, an ambivalent sentiment, interest sentiment, a mood sentiment (e.g., happiness, sadness, anger, ease, frustration, and/or motivation).

In some embodiments, the qualification processing system 10 provides an assessment of a responder's disposition towards a political issue, disposition toward a product or manufacturer, an education level, a quality of communication skills, sincerity, enthusiasm, behavior under pressure, and/or a psychological profile. In some embodiments, the assessment can be based on responses to specific questions targeting an aspect of the responder, textual structure of the responder's responses, and/or audible tonality of the responder's responses. In some embodiments, the qualification processing system 10 uses the semantic similarity between the client's provided materials and responder's answers to calculate a culture fit between the two parties. In some embodiments, the analysis can be based on relationships (e.g., semantic relationships) such as term relationships 112 stored in the database 110.

In some embodiments, the qualification processing system 10 determines a responder's and/or a client's adaptability and skills based on input provided by the assessor. In some embodiments, the qualification processing system 10 via text, spoken message, and/or visual aids, allows a responder to provide feedback to one or more portions of responder information (such as a recorded interview) and/or client information recorded where the system has rated one or more responders and/or clients.

In some embodiments, the qualification processing system 10 electronically distributes responder information, analysis, and/or so forth to a responder and/or a client. In some embodiments, the qualification processing system 10 enables a responder and/or a client to, for example, replay part or the entirety of an interview, review the rankings, sort responders by pre-set criteria, share the result in order to view, listen, and/or poll the ranking with other people, and make determinations In some embodiments, the qualification processing system 10 enables a responder and/or a client to comment, and/or initiate a follow-up action (e.g., an automated interview) with some or all of the responder and/or clients.

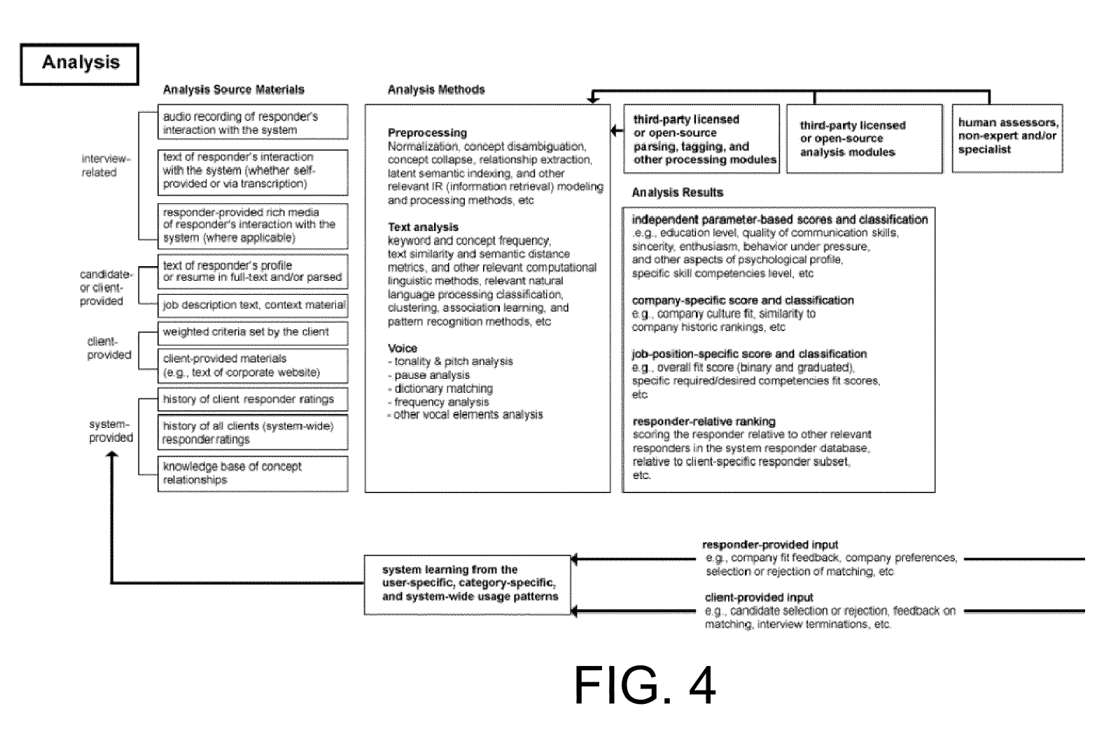

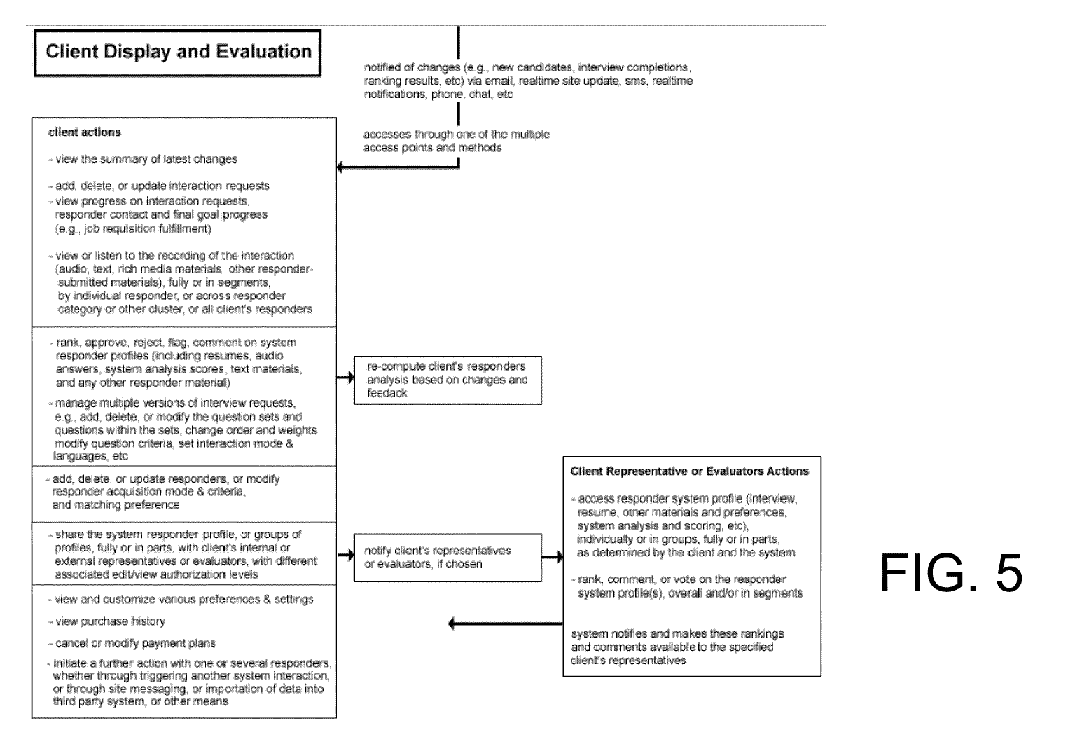

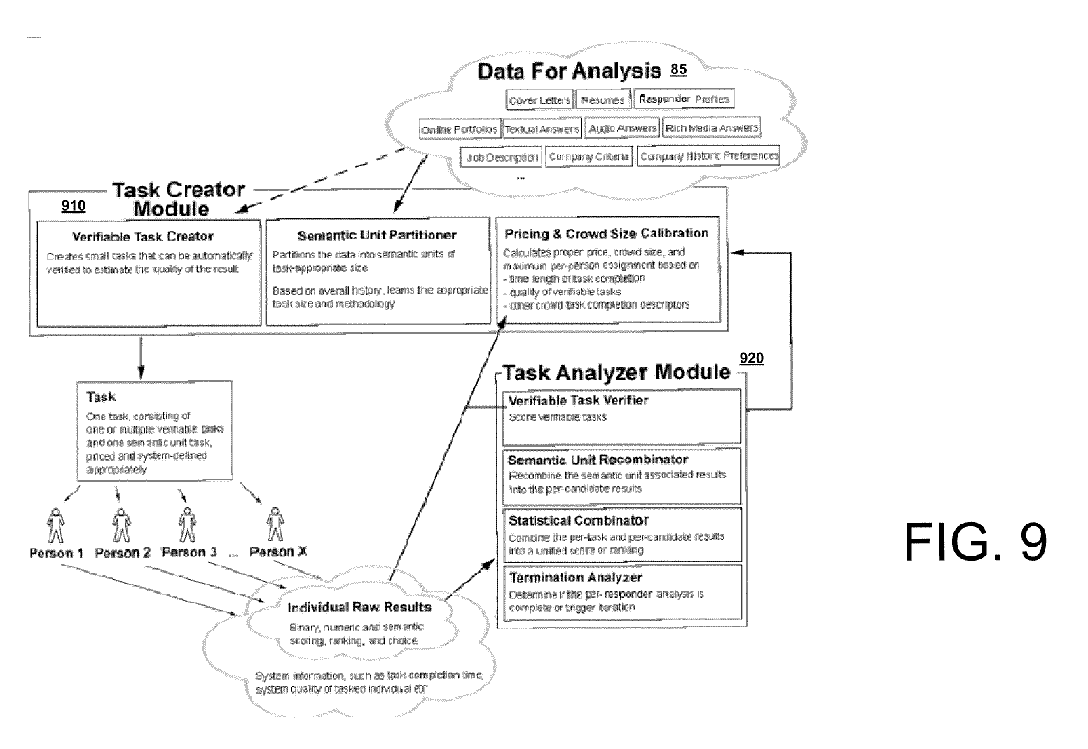

In some embodiments, the qualification processing system 10 collects feedback. In some embodiments, the feedback can either signal agreement or disagreement of the assessor with the system's initial assessment regarding the rating, adaptability, response, and/or skills of one or more responders and/or clients. In some embodiments, the qualification processing system 10 re-computes, in response to feedback, one or more portions of responder information and/or client information to reflect a new rating and/or assessment based on feedback. In some embodiments, the qualification processing system 10 improves automatic rating and assessing capabilities based on feedback provided by a responder and/or a client. In some embodiments, the qualification processing system 10 applies its learning to one or more assessments and/or specific sections of it based on a rules-based algorithm (as defined by a responder and/or a client). More details related to analysis of client and/or responder information is shown in FIG. 4 and FIG. 9, and more details related to feedback are shown in connection with FIG. 5.

In some embodiments, the qualification processing system 10 serves passive or active job seekers by allowing them to perform, for example, an information collection session such as a phone interview.

In some embodiments, the information collection session can include entering of information by the client 162 and/or the responder 152. In some embodiments, the qualification processing system 10 automatically and/or autonomically chooses parameters that will allow the qualification processing system 10 to compute questions that match a candidate's career aspirations. In some embodiments, the qualification processing system 10 enables a responder to self-evaluate an interview and/or share the interview with friends or with a selective group of professionals for free or for a fee, or broadcast to potential interested parties (e.g., employers). In some embodiments, the qualification processing system 10 collects the information provided by a responder and/or a client, collects reviews and comments made by other individuals, and/or computes a ranking for the responder and/or the client.

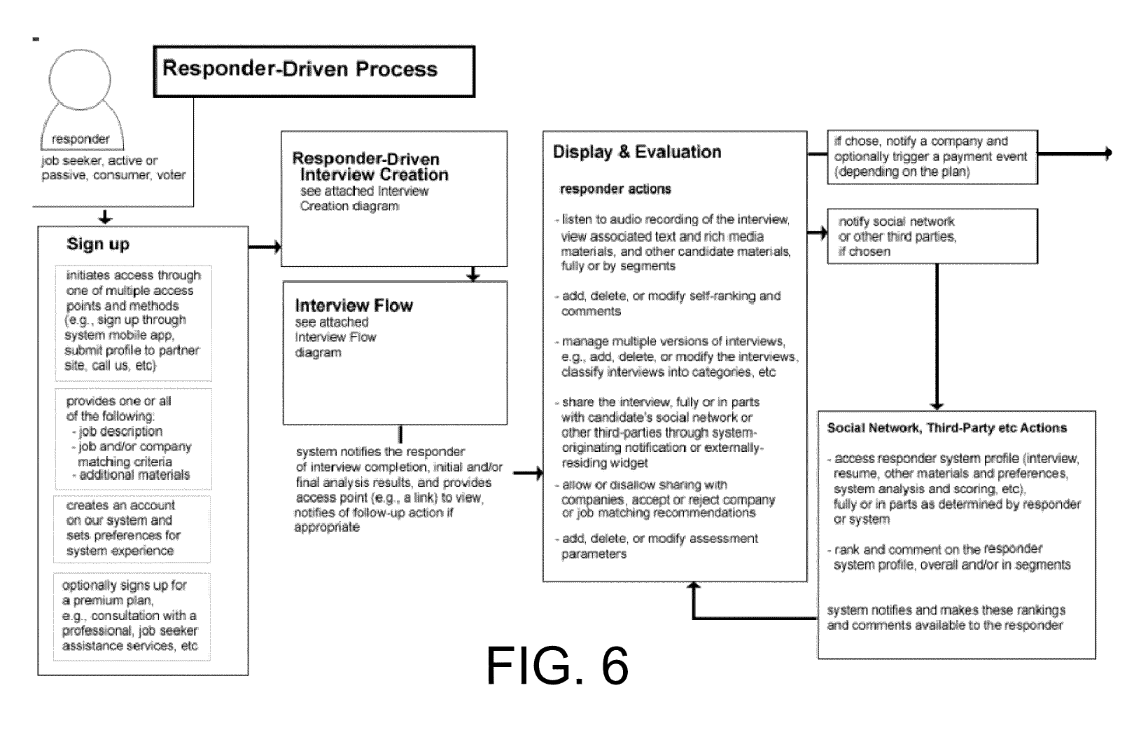

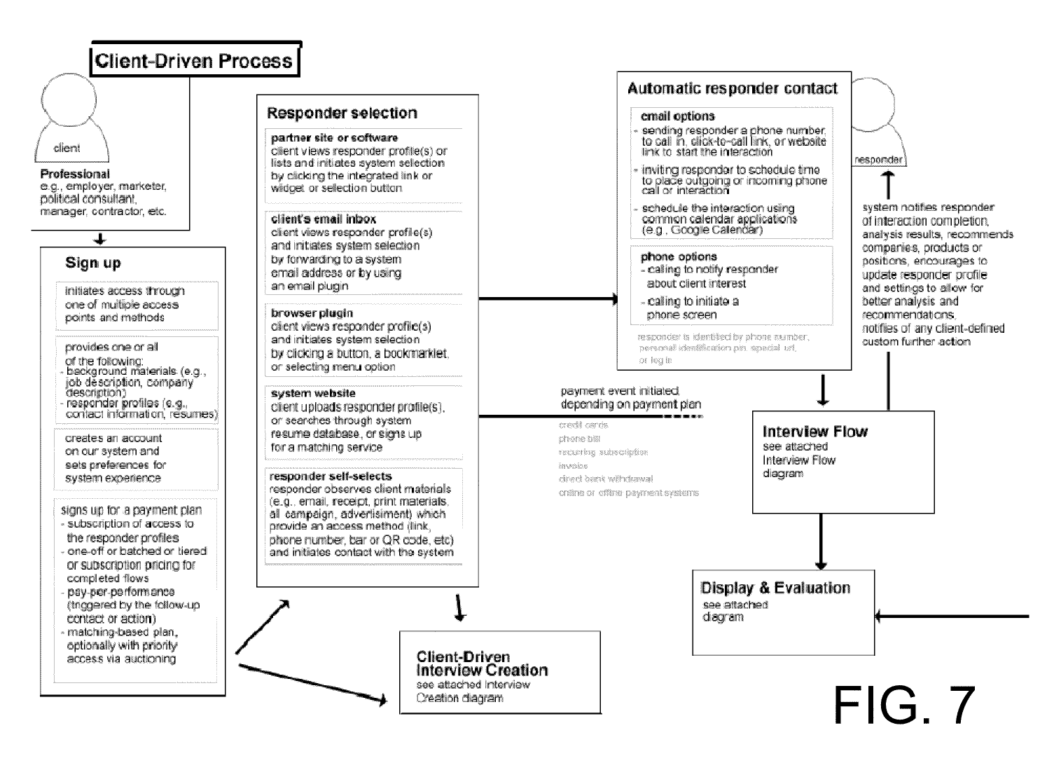

In some embodiments, the qualification processing system 10 can be configured to operate based on a client-driven process and/or based on a responder-driven process. More details related to a responder-driven process are shown in FIG. 6, and more details related to a client-driven process are shown in FIG. 7.

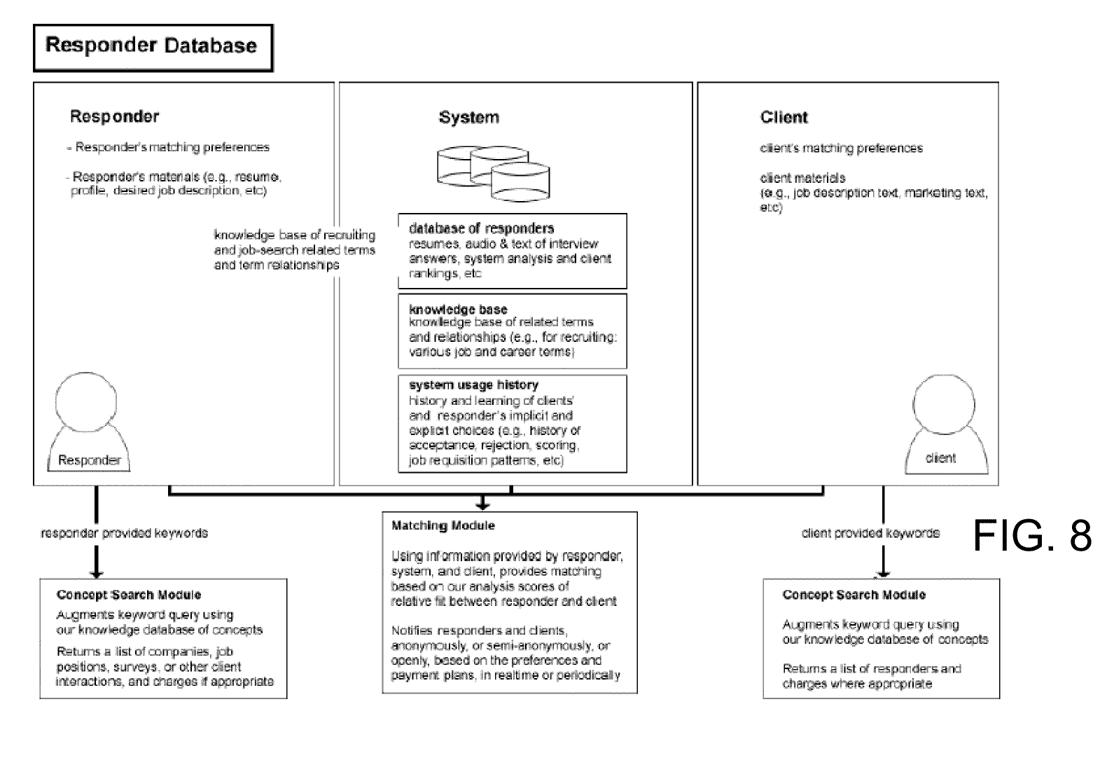

In some embodiments, one or more portions of the database 110 can be searched using keyword, concept, and/or proximity matching. In some embodiments, the database 110 can be searched based on voice input taken from an information collection session such as a responder's (or client's) interview (or interviews), resume, and/or other information that the system gathered and computed. In some embodiments, the client can for example, replay a pre-recorded phone interview, and then follow up with additional interviews with the responder. In some embodiments, the database can be continuously updated with ratings of one or clients and/or responders based on information collection sessions (such as phone interviews). FIG. 8 is a schematic diagram that illustrates at least a portion of the database 110 shown in FIG. 1.

In some embodiments, the qualification processing system 10 functions using one or more different languages. For example, one or more portions of the qualification processing system 10 are translated into and/or deployed in any language or multi-language processes so that, for example, one or more portions of an information collection process (via an interactive interview) can be performed in one or more languages.

In some embodiments, the qualification processing system 10 is configured so that only those authorized to access the qualification processing system 10 may do so. In some embodiments, the qualification processing system 10 is configured so that the responder 152 and/or the client 162 must prove that they are authorized (via a login process) to access the qualification processing system 10. In some embodiments, the credentials of the responder 152 and/or the client 162 must be authenticated before the responder 152 and/or the client 162 may access the qualification processing system 10.

FIG. 9 is a schematic diagram summarizing Applicant's method to process responder information and/or client information. As shown in FIG. 9, the candidate information and/or the client information is collectively referred to as data for analysis 85. As shown in FIG. 9, the data for analysis 85 is processed at a task creator module 910 so that the data for analysis 85 can be evaluated, and an evaluation of the data for analysis 85 (which can be represented by raw results) is processed at the task analyzer module 920 (and/or the task creator module 910). In some embodiments, the processing performed by the task creator module 910 and/or the task analyzer module 920 can be referred to crowd-sourcing evaluation. Specifically, the task creator module 910 and the task analyzer module 920 can trigger evaluation of candidate response relevancy (e.g., absolute and/or relative) to a specific and/or a generic type of activity based on data collected from multiple candidates. The evaluation can be triggered based on one or more tasks assigned to one or more evaluators by the task creator module 910. In some embodiments, a task can include a verifiable task, a semantic unit, task parameter value (which can represent a characteristics, such as an assignment characteristic, of a task), and/or so forth.

As shown in FIG. 9, the task creator module 910 distributes (e.g., send, transmit) one or more portions of the data for analysis 85 to one or more persons “evaluators”(e.g., one or more computing devices associated with one or more persons) for evaluation. In some embodiments, the portion(s) can be distributed to more than one person (e.g., 5 people, 50 people, 1000 people) via respective devices (e.g., computing device of the evaluator). The evaluation can be triggered by one or more tasks and can be represented by raw results shown in FIG. 9 (also can be referred to as individual raw results). In some embodiments, the person(s) can be referred to as evaluators. The evaluations conducted by the evaluators (to produce the raw results) can be processed at the task creator module 910 and/or at the task analyzer module 920.

As shown in FIG. 9, the task creator module 910 optionally comprises a Verifiable Task Creator module, a Sematic Unit Partitioner module, and/or a Pricing and Crowd Size Calibration Module. In some embodiments, the Verifiable Task Creator module analyzes client information (e.g., job requirement information, or sales materials) and/or responder information to create one or several verifiable tasks. The tasks can be related to information that can be used to judge the quality of the overall task result. For example, the tasks can be related to determining the number of required skills, determining whether or not a college degree is required, and/or determining a day of the week.

In some embodiments, the Semantic Unit Partitioner divides client information (e.g., job requirement information or explicitly set criteria) and/or responder information into units for gathering and scoring. In some embodiments, the Sematic Unit Partitioner module divide the information based on a particular criteria (e.g., a maximum) related to efficiency for gathering and scoring the results. In some embodiments, such units can be “candidate resume and job description”, “candidate years of experience and company required years of experience”, and/or “a first candidate profile, a second candidate profile, and activity description.”

In some embodiments, various characteristics related to tasks are defined. The characteristics of the tasks can be referred to as task parameter values. In some embodiments, task characteristics can be defined by the Pricing & Crowd Size Calibration module based on the previous results (e.g., previous raw results, previous statistics defined by the qualification processing module). In some embodiments, a task parameter value comprises, for example, a price, a number of persons assigned to perform one or more tasks, a per-person task level (e.g., maximum level, minimum level), a time period (e.g., a maximum time period, a minimum time period) for completing a task, task quality ranking, and/or so forth.

In some embodiments, the raw results comprise, for example, a rank ordering of at least a portion of the data for analysis 85 and/or a comparison of at least a portion of the data for analysis 85. For example, the evaluators can be presented (by the task creator module 910) with several portions of the data for analysis 85 within a task, and one or more portions of the raw results comprise a rank ordering of the portions of the data for analysis 85. In some embodiments, the rank ordering can be defined based on a comparison of one or more portions of data for analysis 85 (as prompted via a task). In some embodiments, one or more portions of the raw results comprise a written evaluation (or based on a written evaluation) defined by one or more of the evaluators (as prompted via a task). In some embodiments, one or more portions of the raw results can be (or can include) keywords that are associated with a portion of the data for analysis 85 by one or more of the evaluators.

In certain embodiments, Applicant's method will prompt binary decisions (“is the candidate response appropriate or not?”, “does candidate have skill X?”, “does this person sound angry?”, “did the consumer express interest in the product?”), multiple choice (“the candidate is well-qualified or somewhat qualified or not qualified”), rankings (“rank these several candidates based on their competency in skill X”), and/or descriptions (“describe top three strengths of the candidate”). In some embodiments, the Semantic Unit Partitioner module comprises machine learning capability that can be configured to analyze previous system results to guide future unit partitions.

In some embodiments, the task creator module 910 partitions and/or reformats one or more portions of the data for analysis 85 before distributing the data for analysis 85 to selected evaluator(s) for evaluation. For example, a portion of the data for analysis 85 can be subdivided and/or reformatted so that the portion can be evaluated by an evaluator in a desirable fashion. In some embodiments, the portion can be reformatted so that the portion can be presented to the evaluator within a particular type of graphical user interface and/or questions format. In some embodiments, data for analysis 85 can be distributed to the evaluators as tasks (or as overall tasks). In some embodiments, an overall task can be a task that one tasked person/evaluator can access in a single task instantiation.

In some embodiments, the evaluators can be non-expert evaluators (e.g., individuals not affiliated with or in the business of responder information and/or client information evaluation) registered (e.g., at the task creator module 910) as evaluators. In some embodiments, the evaluators and/or portion(s) of the data for analysis 85 can be randomly selected (e.g., selected by the task creator module 910) from a pool or set of evaluators , selected (for receipt of a portion of the data for analysis 85) based on a statistical calculation, and/or evaluator selection criterion. In some embodiments, the evaluators and/or portion(s) of the data for analysis 85 are selected (e.g., selected by the task creator module 910) based on an algorithm.

In some embodiments, the evaluators and/or portion(s) of the data for analysis 85 are selected (e.g., selected by the task creator module 910) based on a predefined order and/or a ranking In some embodiments, one or more of the evaluators and/or portion(s) of the data for analysis 85 can be selected (e.g., selected by the task creator module 910) based on, for example, a user preference (associated with a client and/or a responder).

In some embodiments, one or more portions of the data for analysis 85 are, for example, iteratively analyzed, analyzed based on a feedback loop, analyzed based on a feed-forward loop, and/or so forth, through the module(s) and/or process(es) shown in FIG. 9. In some embodiments, one or more portions of the data for analysis 85 care processed (or re-processed) at the task creator module 910 and/or the task analyzer module 920 based on statistical information related to raw results. For example, a particular type of responder information and/or client information from the data for analysis 85 are re-distributed from the task creator module 910 to a set of evaluators (e.g., more than one evaluator, 50 evaluators) when raw results from an evaluation conducted by another set of evaluators satisfies (or does not satisfy) a particular statistical threshold value (e.g., a quality threshold value) and/or, for example, a threshold (e.g., a standard) defined by an expert evaluator.

In some embodiments, the task analyzer module 920 analyzes one or more portions of the raw results according to a preference of a client and/or a responder. In some embodiments, the task analyzer module 920 analyzes (e.g., statistically analyze, analyze based on an algorithm) one or more portions of the raw results. In some embodiments, one or more portions of the raw results are compared with one or more portions of historical raw results stored at, for example, the database 110 shown in FIG. 1.

As shown in FIG. 9, the task analyzer module 920 optionally comprises a Verifiable Task Verifier module, a Semantic Unit Recombinator module, a Statistical Combinator module, and/or a Termination Analyzer module. In some embodiments, a verifiable task associated with task can be scored at the Verifiable Task Verifier module. In some embodiments, this information, along with other task completion information, such as the average task completion time, system-determined quality of the tasked individuals, and other information is provided to the Pricing & Crowd Size Calibration for later use. In some embodiments, the Semantic Unit Recombinator module and/or the Statistical Combinator module analyzes the raw results to define a unified score or ranking for each responder information and/or client information (e.g., job requirement information or explicitly set criteria) set.

In some embodiments, the Termination Analyzer determines (based on a result from the Semantic Unit Recombinator module and/or the Statistical Combinator module) if the raw result satisfies a threshold condition (e.g., a system-set requirements (e.g., is the result statistically significant, have top X candidates for the job requirement been chosen, have the responders been sorted into three groups, etc)). In some embodiments, if the threshold condition is not satisfied, the Termination Analyzer can be configured to trigger another iteration of task creation by the task creator module 910 for one or more sets of responder information and/or client information (e.g., job requirement information). In some embodiments, data related to analysis at the task analyzer module 920 is stored and/or used to contribute to the future Semantic Partitioner decisions.

FIG. 10 is a schematic diagram that summarizes Applicant's method for processing at qualification processing module. Specifically, the method illustrates processing that can be performed at, for example, various modules of a qualification processing module such as that shown in FIG. 1. The various modules comprise an analysis module (such as analysis module 106 shown in FIG. 1), a task creator module (such as task creator module 910 shown in FIG. 9), a task analyzer module (such as task analyzer module 910 shown in FIG. 9).

As shown in FIG. 10, client and/or responder information is collected, at 1000. For example, job requirement information from an employer or recruiter, or generic job requirement information generated internally and not associated with any open position can be collected. In some embodiments, client information (e.g., company information) can be in the form of a job description (or a portion thereof), a weighted criteria, a set of questions, and/or other relevant material. In some embodiments, the client information can be collected via web, phone, and/or in-person. In some embodiments, the client information can be supplemented by the knowledge of the client's previous requirements and/or previous ratings of results. In some embodiments, the responder information can be collected concurrently or consecutively. In some embodiments, the candidate information can take the form of candidates applying for the job with resume submission, online portfolio, link to or form-submitted profile, phone or video interview, text-based testing, and/or so forth. In some embodiments, the responder information is provided by the client or through a third party.

A task is defined, at 1010. For example, in some embodiments, client information (e.g., job requirement information) and/or responder information can be used to define one or more tasks at, for example, a task creator module such as that shown in FIG. 9. In some embodiments, the task can be assigned to a group of individuals (i.e., evaluators), anonymous or not, expert or not, to evaluate (e.g., vote, rank, score, or describe) the client information and/or responder information presented to them.

As shown in FIG. 10, a result associated with the task is analyzed, at 1012. In some embodiments, the result can be, for example, a raw result. In some embodiments, the result can be analyzed by the Task Analyzer Module after a specified period of time (e.g., a maximum period of time) has passed (as defined within a task parameter value).

In some embodiments, one or more results (e.g., computed results) can be shared on (e.g., shared on an as-needed basis) with the client and/or responder. In some embodiments, the qualification processing module can be configured to trigger additional action, whether based on the responder's response, company response, or self-requirement, to gather additional data, such as follow-up interview, or test, or survey. This data can also be sent through the modules to compute an iterative result.

As an example, a job description for a sales position in a medium-size online publishing firm specializing in travel can be collected. That job requirement can be posted on one or more web sites, mobile devices, computers, print, etc. Several job applicants (e.g., candidates) can apply via resume submission, form fill, test and/or so forth. A set of non-experts (e.g., 50 non-expert evaluators) can be tasked so that each non-expert sees part or all of the job requirement and/or part or all of, for example, two or more candidates' information. The evaluators can then be prompted (via a task) to vote on which candidate data is in better agreement with the requirement. The results can be computed (and once statistical significance achieved) and the size of the number of applicants can be reduced to those who were statistically in better agreement with the requirement. The information associated with the candidates can be sent again for non-expert evaluation until the size of the candidate group matches a specified requirement (e.g., a system requirement, a client preference).

In some embodiments, follow-up action can be triggered with respect to the group of responders. In some embodiments, follow-up can be a phone interview. Once interviews are completed, another set of non-experts (e.g., 70 non-expert evaluators) can be tasked so that each non-expert sees part or all of the job requirement and listens to part or all of, for example, two or more candidates' phone interview recordings. This other set evaluators (which can overlap with the first set of evaluators) can then be prompted (via a task) to vote on which candidate data is in better agreement with the requirement. The results can be computed (and once statistical significance achieved) and the size of the number of applicants can be reduced to those who were statistically in better agreement with the requirement. In some embodiments, this process can be repeated until the size of the candidate group matches a specified requirement.

After the size of the group matches the specified requirement, billing, assessment and/or other functions can be performed by the qualification processing module. In some embodiments, other modules can be configured to provide an employer and/or a recruiter with information related to the narrowing of the original list of candidates to a group of likely hires.

In some embodiments, the task creator module 910 and/or the task analyzer module 920 can be a sub-module within the qualification processing module 100. In some embodiments, the task creator module 910 and/or the task analyzer module 920 is integral with the analysis module 106. In some embodiments, the database 110 shown in FIG. 1 can be used by the task creator module 910 and/or the task analyzer module 920 to perform processing related to the functions associated with these modules.

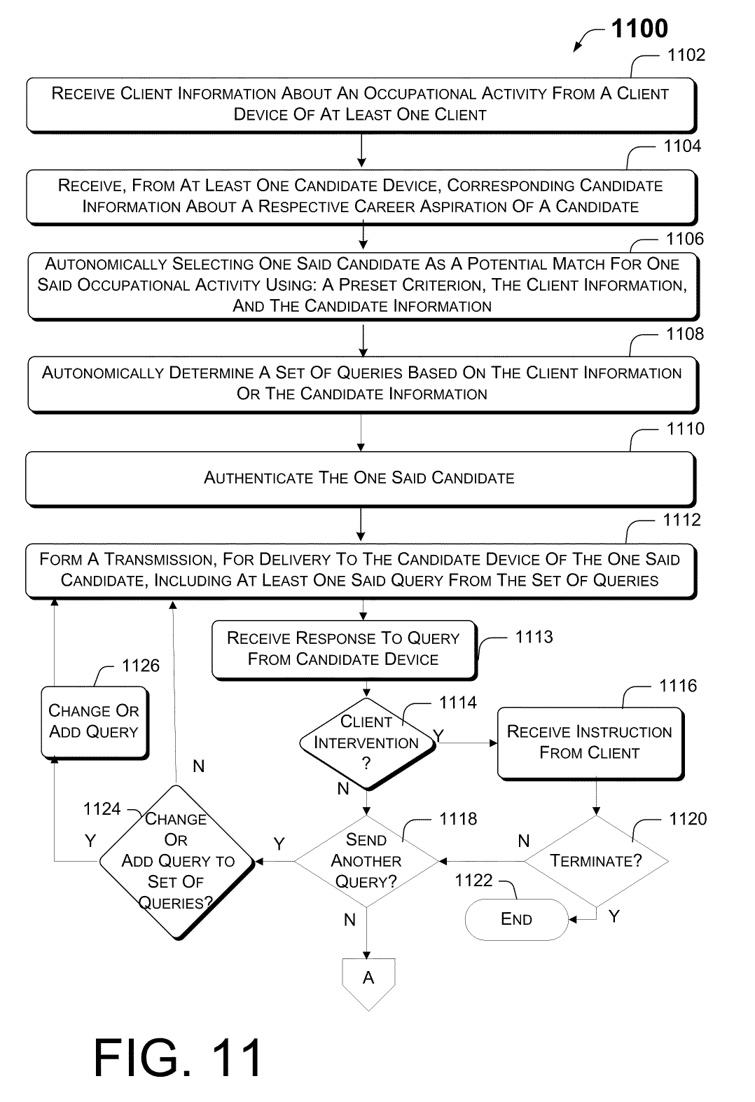

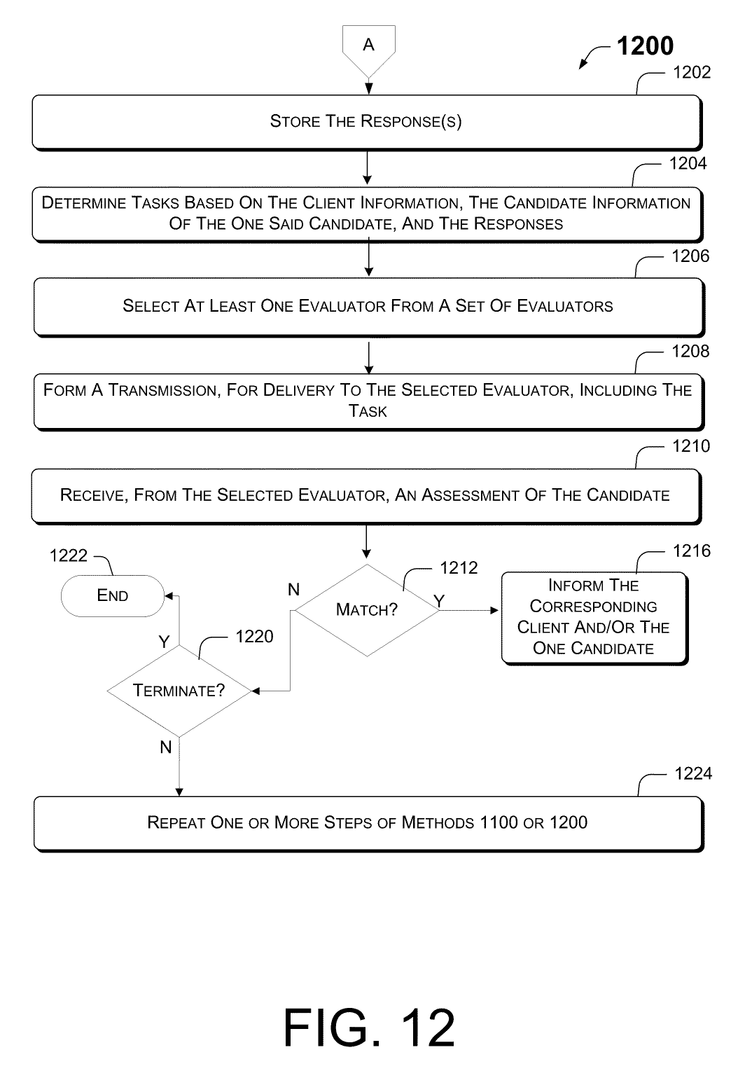

By way of illustration, FIGS. 11 and 12, summarizes Applicant's method 1100, which continues to method 1200, for selecting one or more candidates for an occupational activity. The methods 1100 and 1200 can also be used for other activities (e.g., marketing survey), such as those not associated with an occupation vacancy. At step 1102 client information about an occupational activity is received from a client device of at least one client. The client information may include a job description, a start date, a salary range, a geographic location for the occupational activity, or other parameters that describe the occupational activity, for example. The client information may include a set of queries related to the occupational activity. In one embodiment, the client information includes a client criterion that is usable to select a potential candidate for the occupational activity. For example, the client information may include a ranking or weight for the client queries or parameters that describe the occupational activity. As stated previously, the client information may include a client's sentiments, such as, sentiment's for the question or a context of the question. At step 1104, candidate information about a career aspiration of at least one candidate is received from at least one corresponding candidate device. The candidate information may include a resume, a geographic location in which the career aspiration can be practiced, an expected salary, a type of occupation, a start date, or queries of the candidate, for example.

In some embodiments, the client information and/or the candidate information is received via an interactive user interface that can be rendered on a browser enabled device, such as the client device or the candidate device. To illustrate, a candidate may enter the candidate information into a form communicated to the candidate device via the communication fabric 140 (e.g., the Internet) and rendered on a display of candidate device.

At step 1106, at least one candidate is automatically selected as a potential match for further action using the client information, the candidate information, and/or a preset criterion. The preset criterion may be based on the client criterion included in the client information, a criterion communicated by the candidate in the candidate information, or other preset criterion determined by the qualification processing system (e.g., the qualification processing system 10 of FIG. 1). To illustrate, the qualification processing system may rank a geographical location match between the occupational activity and the geographical location of the career aspiration of the candidate above a match between the occupational activity requested years of experience and the years of experience of the candidate included in the candidate information.

At step 1108, a set of queries are autonomically generated based on the client information and/or the candidate information of the selected candidate of step 1106. Here, the queries within the set of queries may be tailored for the specific clients or for the specific selected candidate. For example, one of the queries within the set of queries may be to further inquire into an experience of the selected candidate based on the candidate information depicted in the resume of the selected candidate. Alternatively, or in combination, as depicted in FIG. 2, the candidate or the client may have identified questions (e.g., question set 210) that become part of the set of queries.

At step 1110, the selected candidate accesses the qualification processing system, such as the qualification processing system 10 of FIG. 1, via the communication fabric 140 for an information session. In one embodiment, the selected candidate is authenticated before access is provided. For example, the selected candidate may enter a unique user ID or password to access the qualification processing system 10.

At a step 1112, a transmission is formed for delivery to the candidate device of the selected candidate. The transmission may include one or more of the queries in the set of queries. At a step 1113, a response to the one or more queries is received from the candidate device of the selected candidate.

At a step 1114, a determination is made whether the client should intervene in the information session. If the client is to intervene, the method 1100 moves from the step 1114 to step 1116. A transmission is sent to the client including a request for further instruction and the candidate information and/or the response to the query. At step 1116, the client provides instructions to the qualification processing system. If the client instructions includes termination of the information session, method 1100 moves from step 1116 to step 1122 and the information session ends at step 1122. If the clients instructions include instructions to continue with the information session, the method 1100 moves from step 1120 to step 1118. Alternatively, or in combination, the client instruction may be to go back (not shown in FIG. 11) to step 1106 in which a determination is made if the selected candidate is a potential match for the occupation activity. If the client is not to intervene at step 1114, the method 1100 moves from the step 1114 to step 1118. Here, if no further queries are to be asked of the selected candidate, the method 1100 moves to the step 1202 of FIG. 12. Alternatively, if another query is to be transmitted to the selected candidate, the method 1100 moves from step 118 to the step 1124. At step 1124, a determination is made if the set of queries should be altered (e.g., add a new query, change an existing query, or delete a query in the set of queries). If the set of queries is not to be altered, the method 1100 moves back to step 1112. Alternatively, if the set of queries is to be altered, the set of queries is altered at step 1126 and the method 1100 moves from step 1126 back to step 1112. Portions of the method 1100 is then repeated until the method 1100 moves to step 1202 of method 1200 in FIG. 12 via off page reference A.

Referring to FIG. 12, the method the 1200 continues the steps of the method 1100 via off page reference A. At a step 1202, the responses to the queries is stored in a database. At a step 1204, tasks are determined based on the client information, the candidate information, and/or the response of the selected candidate. At a step 1206, at least one evaluator from a set of evaluators is selected. At a step 1208, a transmission is formed for delivery to the selected evaluator, including the task determined at step 1204. At a step 1210, an assessment of the candidate based on the task is received from the selected evaluator. At a step 1212, a determination is autonomically made if the selected candidate is a potential match for the occupational activity base don the client information, the candidate information, the response, and/or the assessment received from the selected evaluator. If a match is not found, and the method 1200 is to be terminated at step 1220, the method 1200 ends at step 1222. If the method 1200 is not to be terminated at step 1220, the method continues to step 1224 in which one or more steps of the methods 1100 or 1200 is repeated. Alternatively, if a match is found at step 1212, the method 1200 moves to step 1216 in which the corresponding client and or candidate is informed of the results of the valuation. Any or all of the steps in methods 1100 and 1200 may be repeated or practiced in any order, not necessarily shown.

In other embodiments, methods 1100 and 1200 are used to autonomically evaluate responses of a set of candidates to queries regarding an activity of a client. The set may include one candidate or a plurality of candidates. A set of tasks for evaluating the responses of the candidates are determined. The tasks are allocated to a plurality of evaluators that are unaffiliated to the client. The evaluators assess the responses and send a corresponding assessment of the responses based on the task them back to the qualification processing system. The qualification processing system, in turn, autonomically evaluates the responses based at least in part on the assessment of the evaluators.

For illustrative purposes only, the following describes steps for an exemplary process for use with the qualification processing system 10 of FIG. 1:
The client provides a list of responders or configures a method to acquire multiple responders;
Background information is collected about the client and the responder, wherein the background information comes from the client, the responder, third party, or combination thereof;
The interaction, the query and the criteria to evaluate the interaction are configured;
The interaction is configured by one or more of: the client, the responder, the third party, or the qualification processing system itself, whether manually or algorithmically or both;
The interaction occurs between the system and the responder;
Interaction can be in text, voice, video, etc, and can consist of any combination of these parts (e.g., first text, then voice, then text, then video, etc.);
Interaction can be triggered by the responder calling in, clicking to start, sending a text message based on the information received in an email, voice mail, phone call, print materials, QR code, etc, or by the client via same variety of methods;
Responder's responses to the querying are recorded and analyzed;
Analysis is based on the client criteria & background information, responder's background information, system machine learning or any combination of the above; and is performed by a crowdsourcing algorithm, a machine learning algorithm, or a combination, for example;
Further action is automatically and/or autonomically determined, based on the client pre-set configuration and/or algorithmically;
Further action can be another interaction or a determination or a transaction (e.g., transferring the call to customer support, emailing a coupon, scheduling a face-to-face interview, placing the responder into the sales leads queue system); and
The client and/or the responder are notified and/or have an ability to observe, give feedback on, and share the process and its results.

By way of example, and not by limitation, the following illustrates usage of the qualification processing system 10 for evaluation of client activities:
A restaurant owner registers with the qualification processing system, creates a customer satisfaction survey that consists of 10 questions (e.g., “Did you enjoy the service?”, “Did you eat in the restaurant or order out?”), selects an option to perform survey over the phone, sets criteria for evaluating the responses to the questions (e.g., “Does the person sound angry?”, “Did the person purchase an in-restaurant meal or a meal to-go?”), and provides instructions for follow-up action. Restaurant owner selects an option to generate QR code as the trigger for the interaction, and receives a picture to embed in his receipts.
A consumer visits a restaurant & purchases a meal. Upon payment, the consumer receives a receipt, on which the QR code appears. The consumer scans the QR code with the consumer's mobile device, and receives a link. Clicking on the link initiates consumer's call to the qualification processing system. The consumer's phone number becomes a unique identifier for the consumer, and the interaction is determined by the information contained in the QR code. Consumer answers the 10 questions. The qualification processing system records & analyzes the questions based on the pre-set criteria. The consumer's responses are flagged as “unhappy”, and the consumer automatically receives an email with a $10 coupon to the restaurant and an apology.
The restaurant owner is notified daily about the number of the consumers who took the survey, their classification using his pre-set criteria, and a link to the qualification processing system where the restaurant owner can access the audio recordings of the survey, sort the responders by the criteria, give feedback on the analysis, and trigger additional action.

In some embodiments, one or more portions of the qualification processing system 10 can include a hardware-based module (e.g., a digital signal processor (DSP), a field programmable gate array (FPGA)) and/or a software-based module (e.g., a module of computer code, a set of processor-readable instructions that can be executed at a processor). In some embodiments, one or more of the functions associated with, for example, the qualification processing system 10 can be performed by different modules and/or combined into one or more modules.

In certain embodiments, individual steps recited in FIGS. 10, 11, and/or 12 may be combined, eliminated, or reordered.

In certain embodiments, computer program readable code, such as instructions 196 (FIG. 1), resides in non-transitory computer readable medium 194 (FIG. 1), wherein those instructions are executed by a processor, such as processor 192 (FIG. 1), and/or 142 (FIG. 1), to perform one or more of steps recited in FIG. 10, FIG. 11, and/or FIG. 12.

In other embodiments, the invention comprises computer readable program code residing in any other computer program product, where that computer readable program code is executed by a computer external to, or internal to, system 10 (FIG. 1), to perform one or more of steps recited in FIG. 10, FIG. 11, and/or FIG. 12. In either case, the computer readable program code may be encoded in a non-transitory computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

Examples of computer readable program code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, multiple, distributed qualification processing systems can be configured to operate in parallel.

Although the present invention has been described in detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

We claim:

1. An article of manufacture comprising a processor and a non-transitory computer readable medium having computer readable program code disposed therein to select one or more candidates for an occupational activity, the computer readable program code comprising a series of computer readable program steps to effect:
receiving, from each of a plurality of client devices, client information about an occupational activity of a corresponding client, the client information including a client criterion of the corresponding client for selecting a candidate for a respective said occupational activity;
receiving, from each of a plurality of candidate devices of corresponding candidates, candidate information about a career aspiration of a corresponding candidate;
autonomically selecting one said candidate for further inquiry using the client information associated with the one said occupational activity, and the candidate information of the one said candidate;
autonomically determining a set of queries for the one said candidate based on at least the client information associated with the one said occupational activity and the candidate information of the one said candidate;
forming a first transmission, for delivery to the candidate device of the one said candidate, including at least one query from the set of queries;
receiving, from the candidate device of the one said candidate, a response to the at least one query;
autonomically determining when the one said candidate is a potential match for the one said occupational activity based on at least one of the client information associated with the one said occupational activity, the candidate information of the one said candidate, and the response to the at least one said query; and
forming a second transmission, for delivery to at least one of:
the one said client; and
the one said candidate, the second transmission including data about the potential match of the one said candidate with the one said occupational activity.

2. The article of manufacture of claim 1, the computer readable program code further comprising a series of computer readable program steps to further effect:
after receiving the response, determining when the one said client is to intervene by providing further instruction that is to be used in autonomically determining when the one said candidate is the potential match; and
when the one said client is to intervene:
forming a third transmission, for delivery to the client device of the one said client corresponding to the one said occupational activity, the third transmission including a request for further instruction and at least one of:
the candidate information of the one said candidate; and
the response to the query;
and
receiving an instruction from the client device of the one said client, wherein determining when the one said candidate is the potential match is further based on the instruction from the one said client.

3. The article of manufacture of claim 1, the computer readable program code further comprising a series of computer readable program steps to further effect:
subsequent to receiving the response, altering the set of queries based on the received response; and
repeating the forming the first transmission, wherein the at least one query is selected from the altered set of queries.

4. The article of manufacture of claim 1, the computer readable program code further comprising a series of computer readable program steps to further effect, prior to determining when the one said candidate is the potential match:
autonomically determining a set of tasks for assessing when the one said candidate is the potential match;
selecting at least one evaluator for each task in the set of tasks;
forming a third transmission, for delivery to a device of the at least one evaluator, including a corresponding said task for the evaluator and at least one of:
at least a portion of the client information of the one said client;
at least a portion of the candidate information of the one said candidate; and
the response;
and
receiving, from the device of the at least one evaluator, an assessment of the one said candidate based on the task, wherein determining when the one said candidate is the potential match is further based on the assessment.

5. The article of manufacture of claim 4, the computer readable program code further comprising a series of computer readable program steps to further effect randomly selecting the at least one evaluator from a predetermined set of evaluators.

6. The article of manufacture of claim 4, wherein the at least one evaluator is unaffiliated with the one said client.

7. The article of manufacture of claim 4, the computer readable program code further comprising a series of computer readable program steps to further effect:
transcribing portions of the response that are verbal; and
translating portions of the response that are in a different language than that used by the at least one said evaluator, wherein the third transmission includes the transcribed portions and the translated portions.

8. The article of manufacture of claim 1, the computer readable program code further comprising a series of computer readable program steps to further effect:
repeating for the plurality of said candidates, selecting one said candidate, determining the set of queries, forming the first transmission, and receiving the response;
ranking each said candidate among the said plurality of candidates based on a degree that the corresponding said candidate matches the occupational activity; and
reporting, to the one said client, the ranking of the respective said candidates.

9. The article of manufacture of claim 1, wherein the set of queries includes queries preselected by at least one of:
the one said client; and
the one said candidate.

10. A computer program product encoded in a non-transitory computer readable medium and useable with a programmable computer processor to select one or more candidates for an occupational activity, the computer program product comprising:
computer readable program code which causes said programmable processor to receive, from a client device, client information about an occupational activity of a client;
computer readable program code which causes said programmable processor to receive, from each of a plurality of candidate devices, candidate information about a career aspiration of a corresponding candidate;
computer readable program code which causes said programmable processor to autonomically select one said candidate for further inquiry using the client information and the candidate information;
computer readable program code which causes said programmable processor to autonomically determine a set of queries for the one said candidate based on at least the one of:
the client information; and
the candidate information of the one said candidate;
computer readable program code which causes said programmable processor to send a first transmission to the candidate device of the one said candidate, the first transmission including at least one query from the set of queries;
computer readable program code which causes said programmable processor to receive, from the candidate device, a response to the at least one query;
computer readable program code which causes said programmable processor to determining when the client is to intervene by providing further instruction that is to be used in determining when the one said candidate is a potential match;
computer readable program code which causes said programmable processor to, when the client is to intervene:
form a second transmission, for delivery to the client device, including a request for further instruction and at least one of:
the candidate information of the one said candidate; and
the response to the query;
and
receive an instruction from the client device;
computer readable program code which causes said programmable processor to autonomically determine when the one said candidate is the potential match for the occupational activity based on at least one of the client information, the candidate information, the response, and the instruction of the client; and
computer readable program code which causes said programmable processor to form a third transmission, for delivery to at least one of the client and the one said candidate, including data about the potential match of the one said candidate with the occupational activity.

11. The computer program product defined in claim 10, the computer program product further comprising:
computer readable program code which causes said programmable processor to, subsequent to receiving the response, alter the set of queries based on the received response; and
computer readable program code which causes said programmable processor to repeat the forming the first transmission, wherein the at least one query is selected from the altered set of queries.

12. The computer program product defined in claim 10, the computer program product further comprising:
computer readable program code which causes said programmable processor to, prior to determining when the one said candidate is the potential match, autonomically determine a set of tasks for assessing when the one said candidate is the potential match;
computer readable program code which causes said programmable processor to, prior to determining when the one said candidate is the potential match, select at least one evaluator for each task in the set of tasks;
computer readable program code which causes said programmable processor to, prior to determining when the one said candidate is the potential match, form a fourth transmission, for delivery to a device of the at least one evaluator, including a corresponding said task for the evaluator and at least one of:
at least a portion of the client information of the one said client;
at least a portion of the candidate information of the one said candidate; and
the response;
and
computer readable program code which causes said programmable processor to, prior to determining when the one said candidate is the potential match, receive from the at least one evaluator an assessment of the one said candidate based on the task, wherein determining when the one said candidate is the potential match is further based on the assessment.

13. The computer program product defined in claim 12, wherein the at least one evaluator is unaffiliated with the one said client.

14. A method for selecting one or more candidates for an occupational activity, the method comprising:
receiving, at a computing device from each of a plurality of client devices, client information about an occupational activity of a corresponding client;
receiving, at the computing device from each of a plurality of candidate devices, candidate information about a career aspiration of a corresponding candidate;
autonomically selecting, at the computing device, one said candidate for one said occupational activity for further inquiry using the client information, and the candidate information;
autonomically determining, at the computing device, a set of queries for the one said candidate based on at least one of:
the client information; and
the candidate information;
forming, at the computing device, a first transmission for delivery to the candidate device of the one said candidate, the first transmission including at least one query from the set of queries;
receiving, at the computing device from the candidate device of the one said candidate, a response to the at least one query;
autonomically determining, at the computing device, when the one said candidate is a potential match for the one said occupational activity based on at least one of the client information, the candidate information, and the corresponding response to the at least one said query; and
forming, at the computing device, a second transmission for delivery to at least one of:
the one said client; and
the one said candidate, the second transmission including data about the potential match of the one said candidate with the one said occupational activity.

15. The method of claim 14 further comprising:
after receiving the response, determining, at the computing device, when the one said client is to intervene by providing further instruction that is to be used in autonomically determining when the one said candidate is the potential match; and
when the one said client is to intervene:
forming, at the computing device, a third transmission for delivery to the client device of the one said client corresponding to the one said occupational activity, the third transmission including a request for further instruction and at least one of:
the candidate information of the one said candidate; and
the response to the query;
and
receiving, at the computing device, an instruction from the client device of the one said client, wherein determining when the one said candidate is the potential match is further based on the instruction from the one said client.

16. The method of claim 14 further comprising:
subsequent to receiving the response, altering, at the computing device, the set of queries based on the received response; and
repeating forming the first transmission, wherein the at least one query is selected from the altered set of queries.

17. The method of claim 14 further comprising:
autonomically determining, at the computing device, a set of tasks for assessing when the one said candidate is the potential match;
selecting, at the computing device, at least one evaluator for each task in the set of tasks;
forming, at the computing device, a third transmission for delivery to a device of the at least one evaluator, the third transmission including a corresponding said task for the evaluator and at least one of:
at least a portion of the client information of the one said client;
at least a portion of the candidate information of the one said candidate; and
the response;
and
receiving, at the computing device from the at least one evaluator, an assessment of the one said candidate based on the task, wherein determining when the one said candidate is the potential match is further based on the assessment.

18. The method of claim 17, wherein the at least one evaluator is unaffiliated with the one said client and is selected from a set of evaluators consisting of:
randomly selecting the at least one evaluator;
using a evaluator selection criterion; and
a combination thereof.

19. A computer program product encoded in a non-transitory computer readable medium and useable with a programmable computer processor to evaluate one or more responses of corresponding candidates regarding an activity of a client, the computer program product comprising:
computer readable program code which causes said programmable processor to receive, from a client device, client information about an activity of a client;
computer readable program code which causes said programmable processor to autonomically select a set of candidates for inquiry regarding the activity of the client;
computer readable program code which causes said programmable processor to send a first transmission to a candidate device of each said candidate in the set of candidates, the first transmission including at least one query from a set of queries;
computer readable program code which causes said programmable processor to receive, from the candidate device of each said candidate, a respective response to the at least one query;
computer readable program code which causes said programmable processor to autonomically determine a set of tasks for evaluating the respective responses to the at least one query;
computer readable program code which causes said programmable processor to select a plurality of evaluators for each said task in the set of tasks, wherein each said evaluator is unaffiliated with the client;
computer readable program code which causes said programmable processor to form a second transmission, for delivery to a device of each said evaluator, including a corresponding said task for the respective evaluator and at least one of:
at least a portion of the client information;
the at least one query; and
at least one said response;
computer readable program code which causes said programmable processor to receive, from the device of each said evaluator, a corresponding assessment of the at least one said response based on the corresponding said task for the respective said evaluator; and
computer readable program code which causes said programmable processor to autonomically evaluate the at least one said response based on the assessment received from each said evaluator.

20. The computer program product defined in claim 19, the computer program product further comprising:
computer readable program code which causes said programmable processor to, subsequent to receiving the respective response to the at least one query, alter the set of queries based on the received respective response; and
computer readable program code which causes said programmable processor to repeat the forming the first transmission, wherein the at least one query is selected from the altered set of queries.

21. The computer program product defined in claim 19, wherein the activity is selected from the group consisting of:
a market research;
a customer survey;
a sales call;
a replenish call;
a scheduling call;
a political survey; and
an occupational activity.

22. The computer program product defined in claim 19, the computer program product further comprising computer readable program code which causes said programmable processor to form a third transmission, for delivery to at least one of:
the client; and
the one said candidate in the set of candidates, the third transmission including data about the autonomically evaluated at least one response.
